(19) United States
(12) Patent Application Publication
(10) Pub. No.: US 2026/0302933 A1
(43) Pub. Date: Oct. 1, 2026

(54) POWER CONVERSION DEVICE AND PRE-CHARGING METHOD THEREOF

(71) Applicant: Lite-On Technology Corporation, Taipei (TW)

(72) Inventors: Bo Ruei Ciou, Taipei (TW); Yu Wei Lin, Taipei (TW); Yong-Long Syu, Taipei (TW); Chen Chen, Taipei (TW)

(73) Assignee: Lite-On Technology Corporation, Taipei (TW)

(21) Appl. No.: 19/295,692

(22) Filed: Aug. 10, 2025

Related U.S. Application Data
(60) Provisional application No. 63/781,377, filed on Apr. 1, 2025.

(30) Foreign Application Priority Data
Jul. 8, 2025 (TW) 114125702

(51) Int. Cl. H02M 1/36; H02M 1/00; H02M 3/07

(52) U.S. Cl. CPC H02M 1/36; H02M 1/0025; H02M 3/07

(57) ABSTRACT

A power conversion device and a pre-charging method thereof are provided. The power conversion device includes a power converter, a sensing circuit, and a pre-charging circuit. The power converter includes a flying capacitor. The sensing circuit senses a terminal voltage difference of the flying capacitor to generate a sensing result. The pre-charging circuit pre-charges the flying capacitor during a power-on transient period of the power conversion device and stops the pre-charging of the flying capacitor based on the sensing result. The power converter converts a first direct current (DC) voltage into a second DC voltage for a load circuit during a normal operation period after the power-on transient period.

### CROSS-REFERENCE TO RELATED APPLICATION

This application claims the priority benefit of U.S. Provisional Application No. 63/781,377, filed on Apr. 1, 2025 and Taiwan Application No. 114125702, filed on Jul. 8, 2025. The entirety of each of the above-mentioned patent applications is hereby incorporated by reference herein and made a part of this specification.

### BACKGROUND

### Technical field

The disclosure relates to power supply equipment, and in particular, relates to a power conversion device and a pre-charging method thereof.

### Description of Related Art

Almost all electrical facilities (e.g., consumer electronic products, charging stations, AI servers, automotive electronic equipment, etc.) require power conversion devices. At the startup moment of an electrical facility, key components (e.g., power switches, etc.) in the power conversion device suffer from larger voltage stress (or current stress) most of the time. Excessive voltage stress (or current stress) may damage the key components in the power conversion device.

### SUMMARY

The disclosure provides a power conversion device and a pre-charging method thereof to avoid electrical stress damage to a power converter during a power-on transient period.

In an embodiment of the disclosure, the power conversion device includes a power converter, a sensing circuit, and a pre-charging circuit. The power converter is configured to convert a first direct current (DC) voltage to a second DC voltage and includes a first flying capacitor. The sensing circuit is coupled to the first flying capacitor of the power converter and senses a terminal voltage difference of the first flying capacitor to generate a sensing result. The pre-charging circuit is coupled to the first flying capacitor of the power converter, so as to pre-charge the first flying capacitor during a power-on transient period of the power conversion device. The pre-charging circuit is coupled to the sensing circuit to receive the sensing result and stops the pre-charging of the first flying capacitor based on the sensing result. The power converter converts a first direct current (DC) voltage into a second DC voltage for a load circuit during a normal operation period after the power-on transient period.

In an embodiment of the disclosure, the pre-charging method includes the following steps. A pre-charging circuit of the power conversion device pre-charges a first flying capacitor of a power converter of the power conversion device during a power-on transient period of the power conversion device. A sensing circuit of the power conversion device senses a terminal voltage difference of the first flying capacitor to generate a sensing result to the pre-charging circuit. The pre-charging circuit stops the pre-charging of the first flying capacitor of the power converter based on the sensing result. The power converter converts a first direct current (DC) voltage into a second DC voltage for a load circuit during a normal operation period after the power-on transient period.

In an embodiment of the disclosure, the power conversion device includes a power converter, a sensing circuit, and a pre-charging circuit. The power converter converts an input voltage to an output voltage and includes a flying capacitor. The sensing circuit is coupled to the flying capacitor and senses a voltage across the flying capacitor. The pre-charging circuit is coupled to the power converter. When the voltage across the flying capacitor is less than a reference voltage, the pre-charging circuit charges the flying capacitor.

To sum up, in the embodiments of the disclosure, the power conversion device pre-charges the flying capacitor of the power converter during the power-on transient period, so as to reduce the voltage stress caused by the instantaneous power startup. Therefore, in the power conversion device, electrical stress damage to the power converter is avoided.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit block diagram of an electrical facility according to an embodiment of the disclosure.

FIG. 2 is a schematic flow chart of a pre-charging method of a power conversion device according to an embodiment of the disclosure.

FIG. 3 illustrates a schematic graph of voltage waveforms of the power conversion device according to an embodiment of the disclosure.

FIG. 4 illustrates a schematic circuit diagram of a power converter according to an embodiment of the disclosure.

FIG. 5 illustrates a schematic circuit diagram of a sensing circuit according to an embodiment of the disclosure.

FIG. 6 illustrates a schematic circuit diagram of a pre-charging circuit according to an embodiment of the disclosure.

FIG. 7 illustrates a schematic circuit diagram of the sensing circuit and the pre-charging circuit according to another embodiment of the disclosure.

FIG. 8 illustrates a schematic circuit diagram of the power converter according to another embodiment of the disclosure.

FIG. 9 illustrates a schematic sequence diagram of upper switch signals and lower switch signals according to an embodiment of the disclosure.

FIG. 10 illustrates a schematic circuit diagram of the power converter according to yet another embodiment of the disclosure.

### DESCRIPTION OF THE EMBODIMENTS

The term "coupled to (or connected to)" used in the entire specification (including claims) refers to any direct or indirect connecting means. For instance, if the disclosure describes a first device is coupled (or connected) to a second device, the description should be explained as the first device is connected directly to the second device, or the first device, through connecting other device or using certain connecting means, is connected indirectly to the second device. In addition, terms such as "first" and "second" in the entire specification (including claims) are used only to name the elements or to distinguish different embodiments or scopes and should not be construed as the upper limit or lower limit of the number of elements and should not be construed to limit the order of the elements. Moreover, elements/components/steps with the same reference numerals represent the same or similar parts in the figures and embodiments where appropriate. Elements/components/steps having same reference numerals or same terms are used as cross reference in different embodiments. It should be understood that the features of the following embodiments may be combined with one another. For instance, the features of the second embodiment may be combined with the features of the first embodiment for implementation. A person having ordinary skill in the art may select suitable feature combinations according to actual design needs.

A system is accompanied by large electrical stress (e.g., voltage stress and current stress) at the moment of startup most of the time, and excessive electrical stress has a significant impact on the power converter. In the following embodiments, this problem is solved through pre-charging. In these different embodiments, the electrical stress caused at the moment of system startup may be effectively reduced.

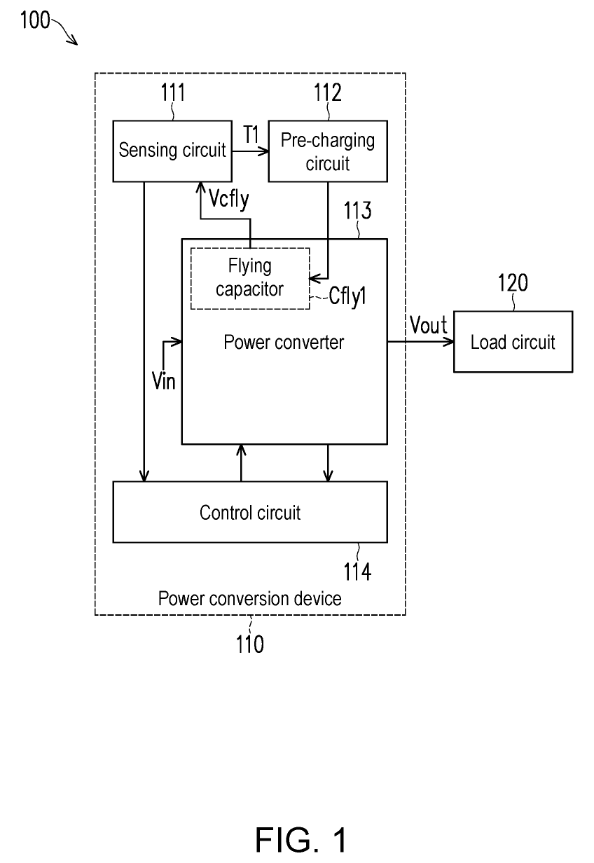

FIG. 1 is a schematic circuit block diagram of an electrical facility 100 according to an embodiment of the disclosure. Based on practical applications, the electrical facility 100 may be consumer electronics, charging stations, artificial intelligence (AI) servers, automotive electronic equipment, or other facilities. In the electrical facility 100, a power conversion device 110 may convert an input voltage Vin (direct current (DC) voltage) into an output voltage Vout (DC voltage) for a load circuit 120. In the embodiment shown in FIG. 1, the power conversion device 110 includes a sensing circuit 111, a pre-charging circuit 112, a power converter 113, and a control circuit 114. The control circuit 114 controls a conversion operation of the power converter 113 during a normal operation period. According to different designs, in some embodiments, the control circuit 114 may be implemented as a hardware circuit. In some other embodiments, the control circuit 114 may be implemented as a combination of multiple ones of hardware, firmware, and software (i.e., programs).

In terms of hardware form, the aforementioned control circuit 114 may be implemented on a logic circuit of an integrated circuit. For instance, the related functions of the control circuit 114 may be implemented in various logic blocks, modules, and circuits in one or a plurality of hardware controllers, microcontrollers, hardware processors, microprocessors, application-specific integrated circuits (ASICs), digital signal processors (DSPs), field programmable gate arrays (FPGAs), central processing units (CPUs), and/or other processing units. The related functions of the control circuit 114 may be implemented as hardware circuits using hardware description languages (e.g., Verilog HDL or VHDL) or other suitable programming languages, such as various logic blocks, modules, and circuits in integrated circuits.

In terms of software and/or firmware, the related functions of the control circuit 114 may be implemented as programming codes. For instance, the control circuit 114 may be implemented by using a general programming language (e.g., C, C++, or an assembly language) or other suitable programming languages. The programming codes may be recorded/stored in a "non-transitory machine-readable storage medium". In some embodiments, the non-transitory machine-readable storage medium includes, for example, a semiconductor memory and/or a storage device. The electronic equipment (e.g., computer, CPU, hardware controller, microcontroller, hardware processor, or microprocessor) can read and execute the programming codes from the non-transitory machine-readable storage medium, so that the related functions of the control circuit 114 are implemented.

Based on actual designs and applications, the power converter 113 may include a DC-DC converter, such as a series capacitor buck converter, a symmetry series capacitor buck converter, or other DC-DC converters. The power converter includes a flying capacitor Cfly1. Based on the control of the control circuit 114, the power converter 113 converts the input voltage Vin into the output voltage Vout for the load circuit 120.

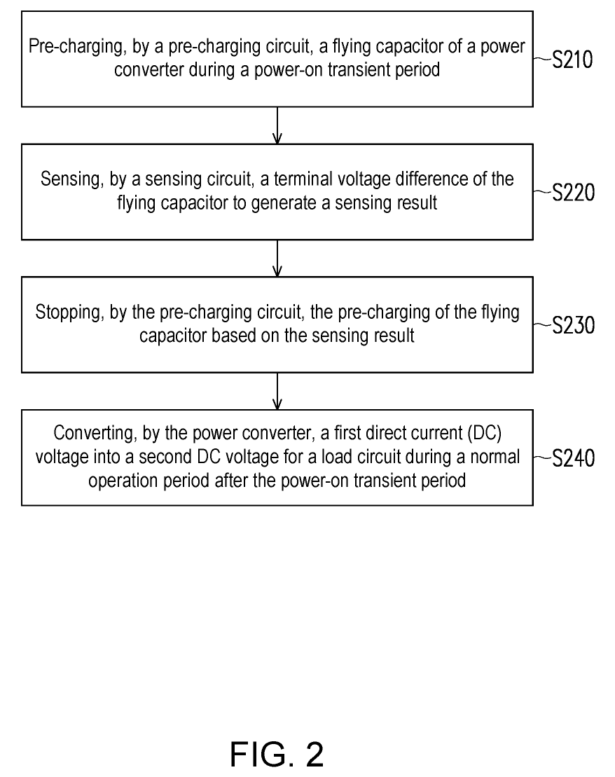

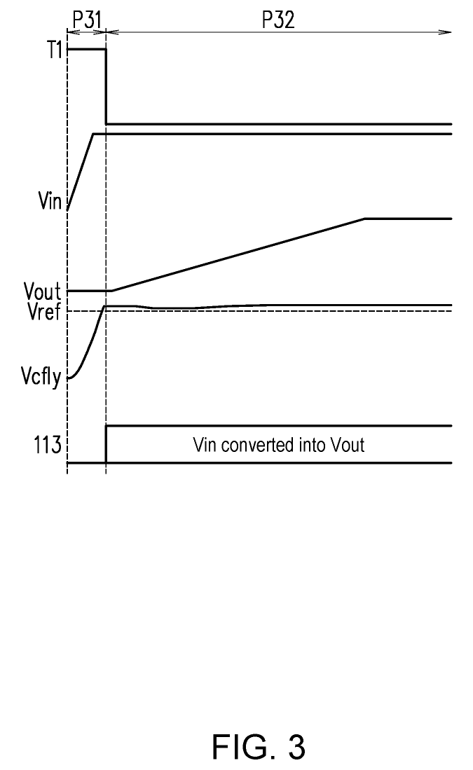

FIG. 2 is a schematic flow chart of a pre-charging method of a power conversion device according to an embodiment of the disclosure. FIG. 3 illustrates a schematic graph of voltage waveforms of the power conversion device 110 according to an embodiment of the disclosure. The horizontal axis of FIG. 3 represents time. Referring to FIG. 1, FIG. 2, and FIG. 3, the pre-charging circuit 112 is coupled to the flying capacitor Cfly1 of the power converter 113, so as to pre-charge the flying capacitor Cfly1 during a power-on transient period P31 of the power conversion device 110 (step S210). For instance, the power-on transient period P31 is the period when a voltage across the flying capacitor Cfly1 is less than a reference voltage Vref. A level of the reference voltage Vref may be determined according to actual designs and applications. For example (but not limited to), the level of the reference voltage Vref may be half a level of the input voltage Vin. Generally, during a shutdown period before the power-on transient period P31, the voltage across the flying capacitor Cfly1 is less than the reference voltage Vref. The sensing circuit 111 senses the voltage across the flying capacitor Cfly1, and when the voltage across the flying capacitor Cfly1 is less than the reference voltage Vref, the pre-charging circuit 112 charges the flying capacitor Cfly1. For example (but not limited to), according to a sensing result (the voltage across the flying capacitor Cfly1) of the sensing circuit 111, the control circuit 114 controls the charging of the flying capacitor Cfly1 by the pre-charging circuit 112. Based on the pre-charging operation of the pre-charging circuit 112, a terminal voltage difference Vcfly of the flying capacitor Cfly1 is raised during the power-on transient period P31.

The sensing circuit 111 is coupled to the flying capacitor Cfly1 of the power converter 113. The sensing circuit 111 senses the terminal voltage difference Vcfly of the flying capacitor Cfly1 to generate a sensing result T1 (step S220). For instance, the sensing circuit 111 changes a level of the sensing result T1 based on a relationship between the terminal voltage difference Vcfly and the reference voltage Vref. The pre-charging circuit 112 is coupled to the sensing circuit 111 to receive the sensing result T1. The pre-charging circuit 112 stops the pre-charging of the flying capacitor Cfly1 based on the sensing result T1 (step S230). For instance, when the voltage across the flying capacitor Cfly1 is greater than the reference voltage Vref, the sensing circuit 111 controls the pre-charging circuit 112 to stop charging the flying capacitor Cfly1.

The control circuit 114 is coupled to the power converter 113 and the sensing circuit 111. The sensing circuit provides the sensing result T1 to the control circuit 114. The control circuit 114 determines an end of the power-on transient period P31 based on the sensing result T1 of the sensing circuit 111. The control circuit 114 enters a normal operation period P32 after the power-on transient period P31 ends to control the conversion operation of the power converter 113. Based on the control of the control circuit 114, the power converter 113 starts to convert the input voltage Vin into the output voltage Vout for the load circuit 120 during the normal operation period P32 (step S240). For instance, when the voltage across the flying capacitor Cfly1 equals half of the input voltage Vin, the control circuit 114 controls the power converter 113 to convert the input voltage Vin into the output voltage Vout.

In summary, the power conversion device 110 pre-charges the flying capacitor Cfly1 of the power converter 113 during the power-on transient period P31, so as to reduce the voltage stress caused by the instantaneous power startup. To be specific, before the control circuit 114 controls the power converter 113 to perform the conversion operation, the pre-charging circuit 112 pre-charges the flying capacitor Cfly1 of the power converter 113 in advance. The sensing circuit 111 detects the voltage across the flying capacitor Cfly1 (terminal voltage difference Vcfly). In response to the terminal voltage difference Vcfly being lower than the reference voltage Vref, the sensing result T1 output by the sensing circuit 111 is at a first level (e.g., high potential, but not limited thereto), so that the pre-charging circuit 112 continuously pre-charges the flying capacitor Cfly1. In response to the terminal voltage difference Vcfly being greater than the reference voltage Vref, the sensing result T1 output by the sensing circuit 111 changes to a second level (e.g., low potential, but not limited thereto). The sensing result T1 at the second level indicates that the pre-charging of the flying capacitor Cfly1 has been completed, for example, the terminal voltage difference Vcfly of the flying capacitor Cfly1 has reached the reference voltage Vref. After the terminal voltage difference Vcfly has reached the reference voltage Vref, the control circuit 114 starts to control the power converter 113 to perform the conversion operation during the normal operation period P32, so that the output voltage Vout rises to a target voltage. A level of the target voltage of the output voltage Vout may be determined according to actual designs and applications. Therefore, in the power conversion device 110, electrical stress damage to the power converter 113 is avoided.

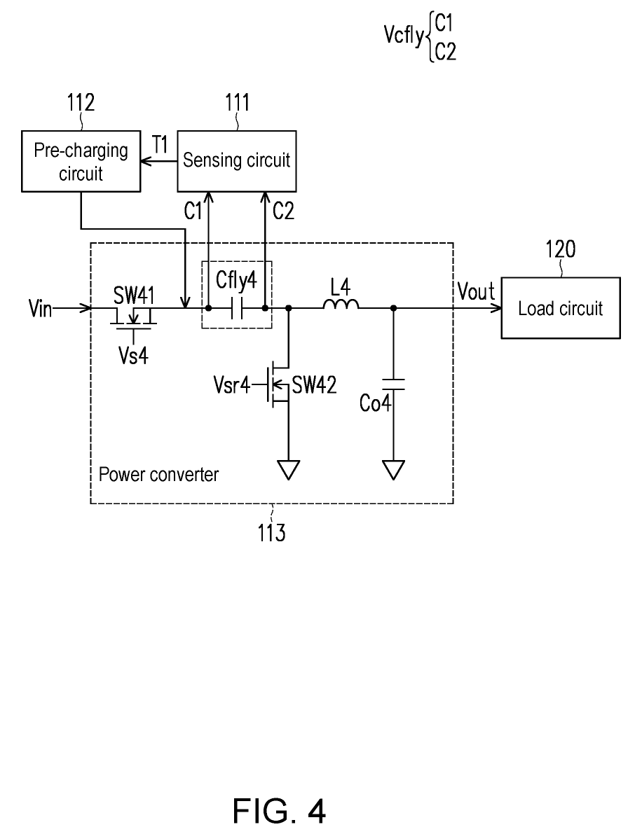

FIG. 4 illustrates a schematic circuit diagram of the power converter 113 according to an embodiment of the disclosure. Description of the sensing circuit 111, the pre-charging circuit 112, the power converter 113, and the load circuit 120 shown in FIG. 4 may refer to the related description of FIG. 1. The power converter 113 shown in FIG. 4 may serve as one of the many implementation examples of the power converter 113 shown in FIG. 1. In the embodiment shown in FIG. 4, the power converter 113 includes an upper power switch SW41, a flying capacitor Cfly4, a lower power switch SW42, an inductor L4, and an output capacitor Co4. The flying capacitor Cfly4 shown in FIG. 4 may serve as one of the many implementation examples of the flying capacitor Cfly1 shown in FIG. 1. Description of the flying capacitor Cfly4 shown in FIG. 4 may refer to the related description of the flying capacitor Cfly1 shown in FIG. 1 and be analogized accordingly.

Referring to FIG. 1 and FIG. 4, a first terminal of the upper power switch SW41 receives the input voltage Vin. A second terminal of the upper power switch SW41 is coupled to a first terminal of the flying capacitor Cfly4. A first terminal of the lower power switch SW42 is coupled to a second terminal of the flying capacitor Cfly4. A second terminal of the lower power switch SW42 receives a reference voltage (e.g., a ground voltage or other fixed voltage). A first terminal of the inductor L4 is coupled to the second terminal of the flying capacitor Cfly4. A second terminal of the inductor L4 is coupled to an output terminal of the power converter 113 (the output terminal of the power converter 113 provides the output voltage Vout to the load circuit 120). A first terminal of the output capacitor Co4 is coupled to the second terminal of the inductor L4. A second terminal of the output capacitor Co4 receives a reference voltage (e.g., a ground voltage or other fixed voltage). A control terminal of the upper power switch SW41 is coupled to the control circuit 114 to receive an upper switch signal Vs4.

The sensing circuit 111 is coupled to the first terminal of the flying capacitor Cfly4 to detect a voltage C1. The sensing circuit 111 is coupled to the second terminal of the flying capacitor Cfly4 to detect a voltage C2. A voltage difference between the voltage C1 and the voltage C2 is the terminal voltage difference Vcfly of the flying capacitor Cfly4. A control terminal of the lower power switch SW42 is coupled to the control circuit 114 to receive a lower switch signal Vsr4. During the normal operation period P32, the control circuit 114 may perform pulse-width modulation (PWM) control on the upper power switch SW41 and the lower power switch SW42 through the upper switch signal Vs4 and the lower switch signal Vsr4.

In summary, the pre-charging circuit 112 pre-charges the flying capacitor Cfly4 during the power-on transient period P31, so as to reduce the voltage stress on the upper power switch SW41 caused by the instantaneous input voltage Vin during power startup. Therefore, electrical stress damage to the upper power switch SW41 may be effectively avoided. The sensing circuit 111 detects voltages C1 and C2 (i.e., detects the terminal voltage difference Vcfly) at both terminals of the flying capacitor Cfly4. In response to the terminal voltage difference Vcfly being lower than the reference voltage Vref, the sensing circuit 111 notifies the pre-charging circuit 112 through the sensing result T1 to continue pre-charging the flying capacitor Cfly4. In response to the terminal voltage difference Vcfly having reached the reference voltage Vref (representing that the pre-charging of the flying capacitor Cfly4 has been completed), the sensing circuit 111 notifies the pre-charging circuit 112 through the sensing result T1 to stop the pre-charging of the flying capacitor Cfly1 and notifies the control circuit 114 to control the power converter 113 to start the conversion operation (converting the input voltage Vin into the output voltage Vout) during the normal operation period P32.

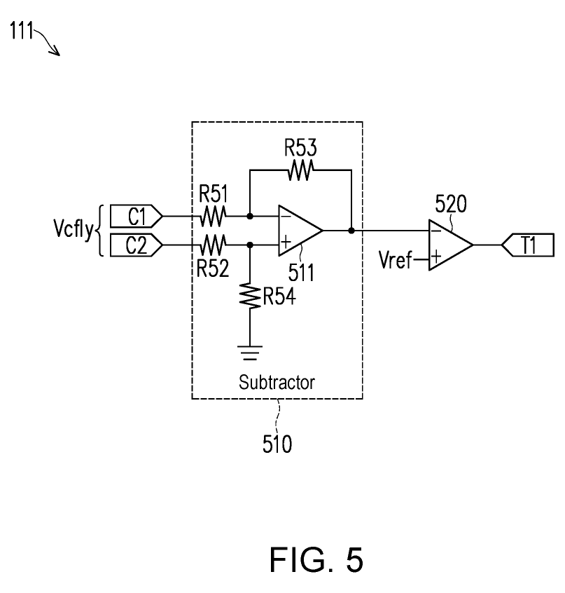

FIG. 5 illustrates a schematic circuit diagram of the sensing circuit 111 according to an embodiment of the disclosure. Description of the sensing circuit 111 shown in FIG. 5 may refer to the related description of FIG. 1 and FIG. 4 The sensing circuit 111 shown in FIG. 5 may serve as one of the many implementation examples of the sensing circuit 111 shown in FIG. 1 and FIG. 4. In the embodiment shown in FIG. 5, the sensing circuit 111 includes a subtractor 510 and a comparator 520. A first input terminal and a second input terminal of the subtractor 510 are respectively coupled to the first terminal and the second terminal of the flying capacitor Cfly4 of the power converter 113 to receive the terminal voltage difference Vcfly (i.e., the voltage difference between the voltage C1 and the voltage C2) of the flying capacitor Cfly4. A first input terminal (e.g., an inverting input terminal) of the comparator 520 is coupled to an output terminal of the subtractor 510. A second input terminal (e.g., a non-inverting input terminal) of the comparator 520 receives the reference voltage Vref. An output terminal of the comparator 520 outputs the sensing result T1 to the pre-charging circuit 112.

In the embodiment shown in FIG. 5, the subtractor 510 includes a resistor R51, a resistor R52, a resistor R53, a resistor R54, and an error amplifier 511. A first terminal of the resistor R51 is coupled to the first input terminal of the subtractor 510, so as to receive the voltage C1. A first terminal of the resistor R53 is coupled to a second terminal of the resistor R51. A first terminal of the resistor R52 is coupled to the second input terminal of the subtractor 510, so as to receive the voltage C2. A first terminal of the resistor R54 is coupled to a second terminal of the resistor R52. A second terminal of the resistor R54 receives a reference voltage (e.g., a ground voltage or other fixed voltage). A first input terminal (e.g., an inverting input terminal) of the error amplifier 511 is coupled to the second terminal of the resistor R51. A second input terminal (e.g., a non-inverting input terminal) of the error amplifier 511 is coupled to the second terminal of the resistor R52. An output terminal of the error amplifier 511 is coupled to a second terminal of the resistor R53 and an output terminal of the subtractor 510, i.e., coupled to the first input terminal (e.g., an inverting input terminal) of the comparator 520.

In response to the output of the error amplifier 511 being lower than the reference voltage Vref, the sensing result T1 output by the comparator 520 is at a high potential, so that the pre-charging circuit 112 continues pre-charging the flying capacitor Cfly4. In response to the output of the error amplifier 511 being greater than the reference voltage Vref, the sensing result T1 output by the comparator 520 becomes a low potential, indicating that the pre-charging of the flying capacitor Cfly4 has been completed. Based on the sensing result T1 becoming a low potential, the pre-charging circuit 112 stops pre-charging the flying capacitor Cfly4, and the control circuit 114 controls the power converter 113 to start the conversion operation (converting the input voltage Vin into the output voltage Vout) during the normal operation period P32.

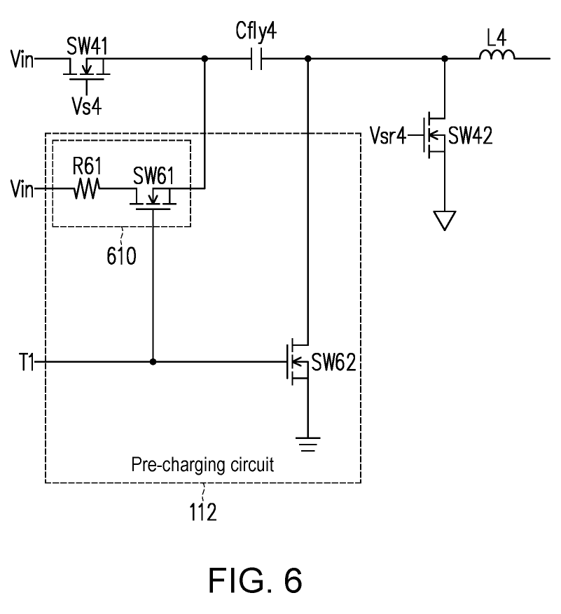

FIG. 6 illustrates a schematic circuit diagram of the pre-charging circuit 112 according to an embodiment of the disclosure. The pre-charging circuit 112 shown in FIG. 6 may serve as one of the many implementation examples of the pre-charging circuit 112 shown in FIG. 1 and FIG. 4. Description of the pre-charging circuit 112, the upper power switch SW41, the flying capacitor Cfly4, the lower power switch SW42, and the inductor L4 shown in FIG. 6 may refer to the related description of FIG. 4. In the embodiment shown in FIG. 6, the pre-charging circuit 112 includes a switch circuit 610 and a pre-charging switch SW62. An input terminal of the switch circuit 610 receives a pre-charging voltage. The pre-charging voltage may be determined according to actual designs and applications. For instance, the input terminal of the switch circuit 610 may receive the input voltage Vin (or other voltage) as the pre-charging voltage. An output terminal of the switch circuit 610 is coupled to the first terminal of the flying capacitor Cfly4 of the power converter 113.

In the embodiment shown in FIG. 6, the switch circuit 610 includes a current-limiting resistor R61 and a pre-charging switch SW61. The current-limiting resistor R61 and the pre-charging switch SW61 are connected in series between the input terminal of the switch circuit 610 and the output terminal of the switch circuit 610. For instance, a first terminal of the current-limiting resistor R61 receives the input voltage Vin, a second terminal of the current-limiting resistor R61 is coupled to a first terminal of the pre-charging switch SW61, and a second terminal of the pre-charging switch SW61 is coupled to the first terminal of the flying capacitor Cfly4. A first terminal of the pre-charging switch SW62 is coupled to the second terminal of the flying capacitor Cfly4. A second terminal of the pre-charging switch SW62 receives a reference voltage (e.g., a ground voltage or other fixed voltage). Control terminals of the pre-charging switches SW61 and SW62 are coupled to the sensing circuit 111 to receive the sensing result T1. The pre-charging switches SW61 and SW62 are turned on during the power-on transient period P31 to pre-charge the flying capacitor Cfly4. During the normal operation period P32 after the power-on transient period P31 ends, the pre-charging switches SW61 and SW62 are turned off to stop pre-charging the flying capacitor Cfly4.

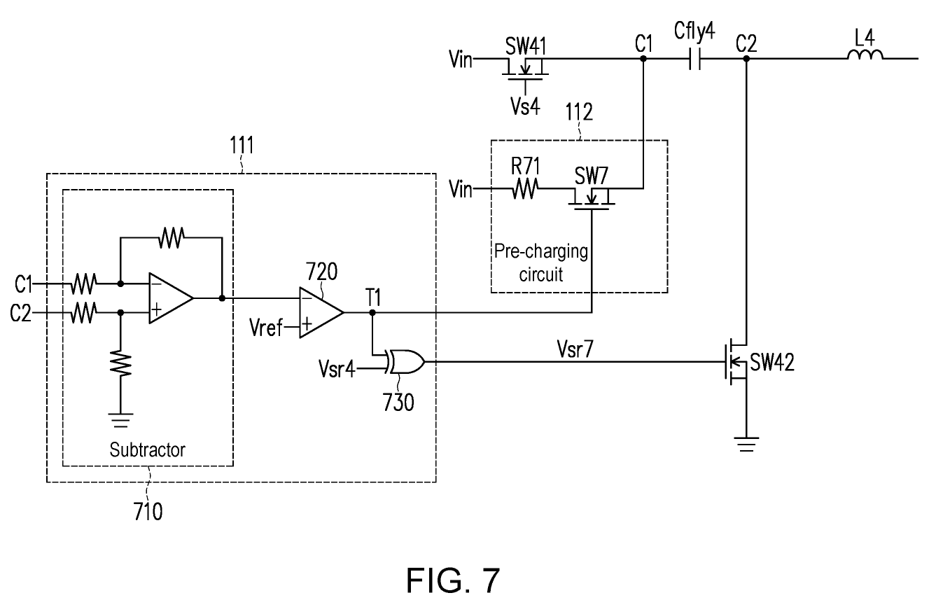

FIG. 7 illustrates a schematic circuit diagram of the sensing circuit 111 and the pre-charging circuit 112 according to another embodiment of the disclosure. The sensing circuit 111 and the pre-charging circuit 112 shown in FIG. 7 may serve as one of the many implementation examples of the sensing circuit 111 and the pre-charging circuit 112 shown in FIG. 1 and FIG. 4. Description of the sensing circuit 111, the pre-charging circuit 112, the upper power switch SW41, the flying capacitor Cfly4, the lower power switch SW42, and the inductor L4 shown in FIG. 7 may refer to the related description of FIG. 4. In the embodiment shown in FIG. 7, the pre-charging circuit 112 includes a switch circuit, and the switch circuit includes a current-limiting resistor R71 and a pre-charging switch SW7. Description of the current-limiting resistor R71 and the pre-charging switch SW7 shown in FIG. 7 may refer to the related description of the current-limiting resistor R61 and the pre-charging switch SW61 shown in FIG. 6 and may be analogized accordingly, so description thereof is not repeated in detail herein.

In the embodiment shown in FIG. 7, the sensing circuit 111 includes a subtractor 710, a comparator 720, and a logic gate 730. Description of the subtractor 710 and the comparator 720 shown in FIG. 7 may refer to the related description of the subtractor 510 and the comparator 520 shown in FIG. 5 and may be analogized accordingly, so description thereof is not repeated in detail herein. According to actual designs and applications, the logic gate 730 may be an exclusive-OR gate (XOR gate) or other logic gates. A first input terminal of the logic gate 730 is coupled to an output terminal of the comparator 720 to receive the sensing result T1. A second input terminal of the logic gate 730 is coupled to the control circuit 114 to receive the lower switch signal Vsr4. An output terminal of the logic gate 730 is coupled to the control terminal of the lower power switch SW42 of the power converter 113 to provide a lower switch signal Vsr7.

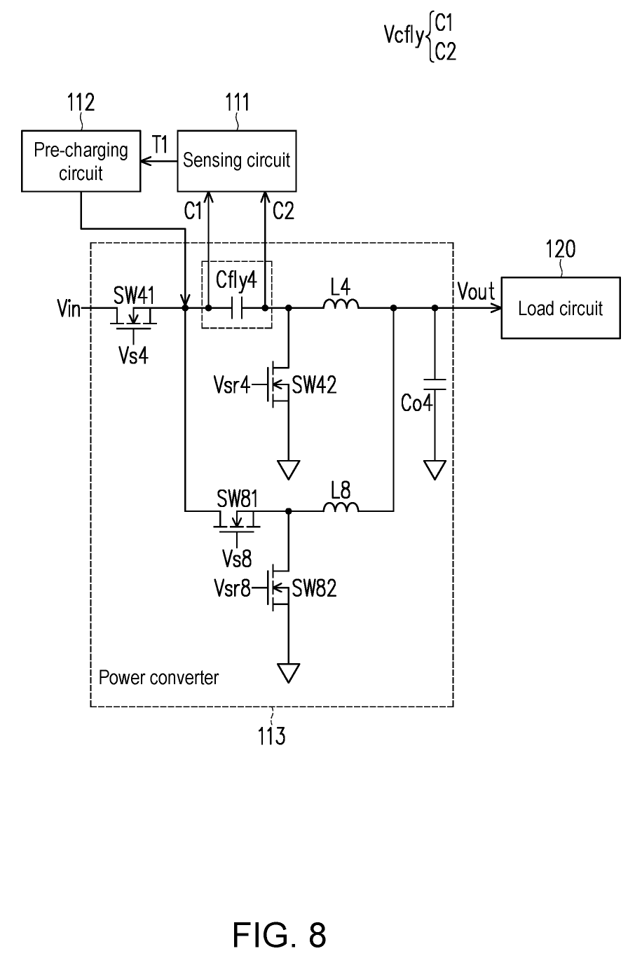

FIG. 8 illustrates a schematic circuit diagram of the power converter 113 according to another embodiment of the disclosure. Description of the power converter 113 and the load circuit 120 shown in FIG. 8 may refer to the related description of FIG. 1. Description of the sensing circuit 111 shown in FIG. 8 may refer to the related description of FIG. 1, FIG. 4, FIG. 5, and FIG. 7 and may be analogized accordingly. Description of the pre-charging circuit 112 shown in FIG. 8 may refer to the related description of FIG. 1, FIG. 4, FIG. 6, and FIG. 7 and may be analogized accordingly. The power converter 113 shown in FIG. 8 may serve as one of the many implementation examples of the power converter 113 shown in FIG. 1. In the embodiment shown in FIG. 8, the power converter 113 includes the upper power switch SW41, the flying capacitor Cfly4, the lower power switch SW42, the inductor L4, an upper power switch SW81, a lower power switch SW82, an inductor L8, and the output capacitor Co4.

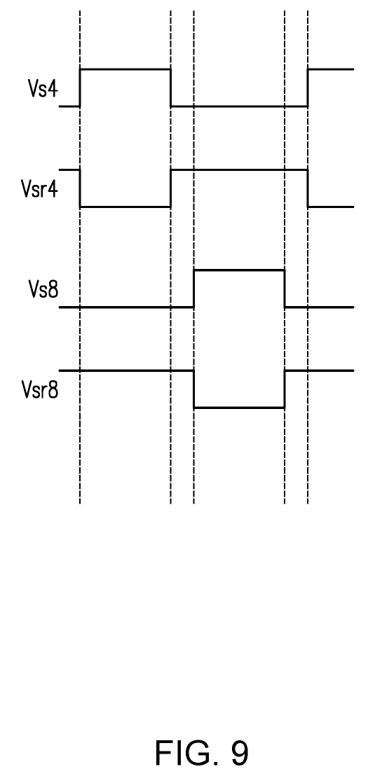

FIG. 9 illustrates a schematic sequence diagram of the upper switch signal Vs4, the lower switch signal Vsr4, an upper switch signal Vs8, and a lower switch signal Vsr8 according to an embodiment of the disclosure. The horizontal axis of FIG. 9 represents time. The upper switch signal Vs4, the lower switch signal Vsr4, the upper switch signal Vs8, and the lower switch signal Vsr8 shown in FIG. 9 may serve as one of the many implementation examples of the upper switch signal Vs4, the lower switch signal Vsr4, the upper switch signal Vs8, and the lower switch signal Vsr8 shown in FIG. 8. Description of the upper switch signal Vs4 and the lower switch signal Vsr4 shown in FIG. 4 may also refer to the related description of FIG. 9. Please refer to FIG. 1, FIG. 8, and FIG. 9, the control terminal of the upper power switch SW41 is coupled to the control circuit 114 to receive the upper switch signal Vs4. The control terminal of the lower power switch SW42 is coupled to the control circuit 114 to receive the lower switch signal Vsr4. A control terminal of the upper power switch SW81 is coupled to the control circuit 114 to receive the upper switch signal Vs8. A control terminal of the lower power switch SW82 is coupled to the control circuit 114 to receive the lower switch signal Vsr8.

Description of the power converter 113 shown in FIG. 8 including the upper power switch SW41, the flying capacitor Cfly4, the lower power switch SW42, the inductor L4, and the output capacitor Co4 may refer to the related description of FIG. 4, so description thereof is not repeated herein. A first terminal of the upper power switch SW81 is coupled to the second terminal of the upper power switch SW41. A first terminal of the lower power switch SW82 is coupled to a second terminal of the upper power switch SW81. A second terminal of the lower power switch SW82 receives a reference voltage (e.g., a ground voltage or other fixed voltage). A first terminal of the inductor L8 is coupled to the second terminal of the upper power switch SW81. A second terminal of the inductor L8 is coupled to the output terminal of the power converter 113, so as to provide the output voltage Vout to the load circuit 120 together with the inductor L4.

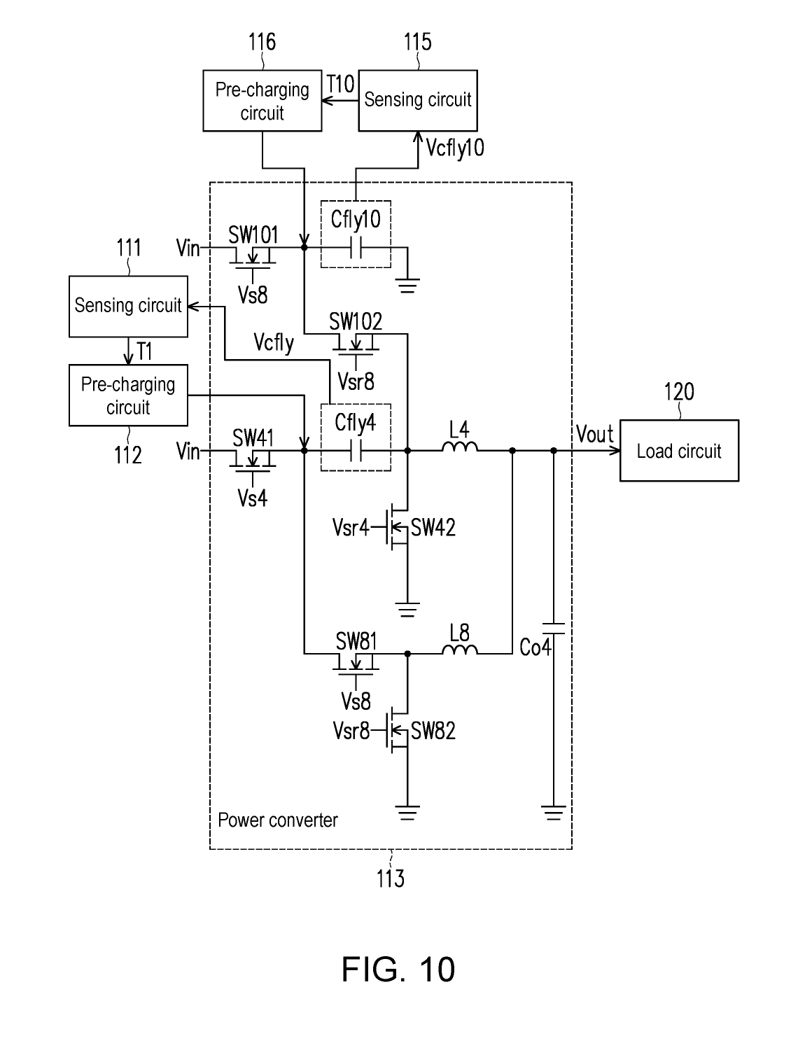

FIG. 10 illustrates a schematic circuit diagram of the power converter 113 according to yet another embodiment of the disclosure. Description of the power converter 113 and the load circuit 120 shown in FIG. 10 may refer to the related description of FIG. 1. Description of the sensing circuit 111 and a sensing circuit 115 shown in FIG. 10 may refer to the related description of FIG. 1, FIG. 4, FIG. 5, and FIG. 7 and may be analogized accordingly. Description of the sensing circuit 112 and the pre-charging circuit 116 shown in FIG. 10 may refer to the related description of FIG. 1, FIG. 4, FIG. 6, and FIG. 7 and may be analogized accordingly. The sensing circuit 115 detects detects a voltage across a flying capacitor Cfly10 (i.e., detects a terminal voltage difference Vcfly10). In response to the terminal voltage difference Vcfly10 being lower than the reference voltage, the sensing circuit 115 notifies the pre-charging circuit 116 through a sensing result T10 to continue pre-charging the flying capacitor Cfly10. In response to the terminal voltage difference Vcfly10 having reached the reference voltage (representing that the pre-charge of the flying capacitor Cfly10 has been completed), the sensing circuit 115 notifies the pre-charging circuit 116 through the sensing result T10 to stop the pre-charge performed on the flying capacitor Cfly10 and notifies the control circuit 114 to control the power converter 113 to start performing the conversion operation (converting the input voltage Vin into the output voltage Vout) during the normal operation period P32. Description of the sensing circuit 115, the pre-charging circuit 116, and the flying capacitor Cfly10 shown in FIG. 10 may refer to the related description of the sensing circuit 111, the pre-charging circuit 112, and the flying capacitor Cfly4 and be analogized accordingly, so description thereof is not repeated herein.

The power converter 113 shown in FIG. 10 may serve as one of the many implementation examples of the power converter 113 shown in FIG. 1. In the embodiment shown in FIG. 10, the power converter 113 includes the upper power switch SW41, the flying capacitor Cfly4, the lower power switch SW42, the inductor L4, the upper power switch SW81, the lower power switch SW82, the inductor L8, an upper power switch SW101, a lower power switch SW102, the flying capacitor Cfly10, and the output capacitor Co4. Description of the upper power switch SW41, the flying capacitor Cfly4, the lower power switch SW42, the inductor L4, the upper power switch SW81, the lower power switch SW82, the inductor L8, and the output capacitor Co4 shown in FIG. 10 may refer to the related description of FIG. 8, so description thereof is not repeated herein. A first terminal of the upper power switch SW101 receives the input voltage Vin. A first terminal of the lower power switch SW102 is coupled to a second terminal of the upper power switch SW101. A second terminal of the lower power switch SW102 is coupled to the second terminal of the flying capacitor Cfly4. A first terminal of the flying capacitor Cfly10 is coupled to the second terminal of the upper power switch SW101. A second terminal of the flying capacitor Cfly10 receives a reference voltage (e.g., a ground voltage or other fixed voltage).

The control terminal of the upper power switch SW41 is coupled to the control circuit 114 to receive the upper switch signal Vs4. The control terminal of the lower power switch SW42 is coupled to the control circuit 114 to receive the lower switch signal Vsr4. Control terminals of the upper power switches SW81 and SW101 are coupled to the control circuit 114 to receive the upper switch signal Vs8. Control terminals of the lower power switches SW82 and SW102 are coupled to the control circuit 114 to receive the lower switch signal Vsr8. The upper switch signal Vs4, the lower switch signal Vsr4, the upper switch signal Vs8, and the lower switch signal Vsr8 shown in FIG. 9 may serve as one of the many implementation examples of the upper switch signal Vs4, the lower switch signal Vsr4, the upper switch signal Vs8, and the lower switch signal Vsr8 shown in FIG. 10.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A power conversion device, comprising:
a power converter configured to convert a first direct current (DC) voltage to a second DC voltage and comprising a first flying capacitor;
a sensing circuit coupled to the first flying capacitor of the power converter and sensing a terminal voltage difference of the first flying capacitor to generate a sensing result; and
a pre-charging circuit coupled to the first flying capacitor of the power converter to pre-charge the first flying capacitor during a power-on transient period of the power conversion device, coupled to the sensing circuit to receive the sensing result, and stopping the pre-charging of the first flying capacitor based on the sensing result, wherein the power converter converts the first DC voltage into the second DC voltage for a load circuit during a normal operation period after the power-on transient period.

2. The power conversion device according to claim 1, further comprising:
a control circuit coupled to the power converter and the sensing circuit, wherein the sensing circuit further provides the sensing result to the control circuit, and the control circuit determines an end of the power-on transient period based on the sensing result of the sensing circuit and enters the normal operation period to control a conversion operation of the power converter after the power-on transient period ends.

3. The power conversion device according to claim 1, wherein the power converter further comprises:
a first upper power switch, wherein a first terminal of the first upper power switch receives the first DC voltage, a second terminal of the first upper power switch is coupled to a first terminal of the first flying capacitor, and a control terminal of the first upper power switch is coupled to a control circuit to receive a first upper switch signal;
a first lower power switch, wherein a first terminal of the first lower power switch is coupled to a second terminal of the first flying capacitor, a second terminal of the first lower power switch receives a first reference voltage, and a control terminal of the first lower power switch is coupled to the control circuit to receive a first lower switch signal; and
a first inductor, wherein a first terminal of the first inductor is coupled to the second terminal of the first flying capacitor, a second terminal of the first inductor is coupled to an output terminal of the power converter, and the output terminal of the power converter outputs the second DC voltage to the load circuit.

4. The power conversion device according to claim 3, wherein the power converter further comprises:
an output capacitor, wherein a first terminal of the output capacitor is coupled to the second terminal of the first inductor, and a second terminal of the output capacitor receives a second reference voltage.

5. The power conversion device according to claim 3, wherein the power converter further comprises:
a second upper power switch, wherein a first terminal of the second upper power switch is coupled to the second terminal of the first upper power switch, and a control terminal of the second upper power switch is coupled to the control circuit to receive a second upper switch signal;
a second lower power switch, wherein a first terminal of the second lower power switch is coupled to a second terminal of the second upper power switch, a second terminal of the second lower power switch receives a second reference voltage, and a control terminal of the second lower power switch is coupled to the control circuit to receive a second lower switch signal; and
a second inductor, wherein a first terminal of the second inductor is coupled to the second terminal of the second upper power switch, and a second terminal of the second inductor is coupled to the output terminal of the power converter.

6. The power conversion device according to claim 5, wherein the power converter further comprises:
a third upper power switch, wherein a first terminal of the third upper power switch receives the first DC voltage, and a control terminal of the third upper power switch is coupled to the control circuit to receive a third upper switch signal;
a third lower power switch, wherein a first terminal of the third lower power switch is coupled to a second terminal of the third upper power switch, a second terminal of the third lower power switch is coupled to the second terminal of the first flying capacitor, and a control terminal of the third lower power switch is coupled to the control circuit to receive a third lower switch signal; and
a second flying capacitor, wherein a first terminal of the second flying capacitor is coupled to the second terminal of the third upper power switch, and a second terminal of the second flying capacitor receives a third reference voltage.

7. The power conversion device according to claim 1, wherein the sensing circuit comprises:
a subtractor, wherein a first input terminal and a second input terminal of the subtractor are respectively coupled to a first terminal and a second terminal of the first flying capacitor of the power converter to receive the terminal voltage difference of the first flying capacitor; and
a comparator, wherein a first input terminal of the comparator is coupled to an output terminal of the subtractor, a second input terminal of the comparator receives a first reference voltage, and an output terminal of the comparator outputs the sensing result.

8. The power conversion device according to claim 7, wherein the subtractor comprises:
a first resistor, wherein a first terminal of the first resistor is coupled to the first input terminal of the subtractor;
a second resistor, wherein a first terminal of the second resistor is coupled to the second input terminal of the subtractor;
a third resistor, wherein a first terminal of the third resistor is coupled to a second terminal of the first resistor;
a fourth resistor, wherein a first terminal of the fourth resistor is coupled to a second terminal of the second resistor, and a second terminal of the fourth resistor receives a second reference voltage; and
an error amplifier, wherein a first input terminal of the error amplifier is coupled to the second terminal of the first resistor, a second input terminal of the error amplifier is coupled to the second terminal of the second resistor, and an output terminal of the error amplifier is coupled to a second terminal of the third resistor and the output terminal of the subtractor.

9. The power conversion device according to claim 7, wherein the sensing circuit further comprises:
a logic gate, wherein a first input terminal of the logic gate is coupled to the output terminal of the comparator to receive the sensing result, a second input terminal of the logic gate is coupled to a control circuit to receive a first lower switch signal, and an output terminal of the logic gate is coupled to the power converter to provide a second lower switch signal.

10. The power conversion device according to claim 1, wherein the pre-charging circuit comprises:
a switch circuit, wherein an input terminal of the switch circuit receives a pre-charging voltage, an output terminal of the switch circuit is coupled to a first terminal of the first flying capacitor of the power converter, the switch circuit comprises a current-limiting resistor and a first pre-charging switch connected in series between the input terminal of the switch circuit and the output terminal of the switch circuit, a control terminal of the first pre-charging switch is coupled to the sensing circuit to receive the sensing result, and the first pre-charging switch is turned on during the power-on transient period to pre-charge the first flying capacitor.

11. The power conversion device according to claim 10, wherein the pre-charging circuit further comprises:
a second pre-charging switch, wherein a first terminal of the second pre-charging switch is coupled to a second terminal of the first flying capacitor of the power converter, a second terminal of the second pre-charging switch receives a reference voltage, and a control terminal of the second pre-charging switch is coupled to the sensing circuit to receive the sensing result.

12. A pre-charging method of a power conversion device, comprising:
pre-charging, by a pre-charging circuit of the power conversion device, a first flying capacitor of a power converter of the power conversion device during a power-on transient period of the power conversion device;
sensing, by a sensing circuit of the power conversion device, a terminal voltage difference of the first flying capacitor to generate a sensing result to the pre-charging circuit;
stopping, by the pre-charging circuit, the pre-charging of the first flying capacitor of the power converter based on the sensing result; and
converting, by the power converter, a first direct current (DC) voltage into a second DC voltage for a load circuit during a normal operation period after the power-on transient period.

13. The pre-charging method according to claim 12, further comprising:
providing, by the sensing circuit, the sensing result to a control circuit of the power conversion device, wherein the control circuit is coupled to the power converter and the sensing circuit;
determining, by the control circuit, an end of the power-on transient period based on the sensing result of the sensing circuit; and
entering, by the control circuit, the normal operation period to control a conversion operation of the power converter after the power-on transient period ends.

14. A power conversion device, comprising:
a power converter converting an input voltage to an output voltage and comprising a flying capacitor;
a sensing circuit coupled to the flying capacitor and sensing a voltage across the flying capacitor; and
a pre-charging circuit coupled to the power converter, wherein when the voltage across the flying capacitor is less than a reference voltage, the pre-charging circuit charges the flying capacitor.

15. The power conversion device according to claim 14, wherein when the voltage across the flying capacitor is greater than the reference voltage, the pre-charging circuit stops charging the flying capacitor.

16. The power conversion device according to claim 14, wherein the reference voltage is less than or equal to one-half of the input voltage.

17. The power conversion device according to claim 14, further comprising:
a control circuit coupled to the power converter and the sensing circuit controlling the pre-charging circuit according to the voltage across the flying capacitor, wherein when the voltage across the flying capacitor equals one-half of the input voltage, the control circuit controls the power converter to convert the input voltage into the output voltage.
